(19) United States
(12) Patent Application Publication
(10) Pub. No.: US 2008/0248239 A1
(43) Pub. Date: Oct. 9, 2008

(54) Wet wipes having increased stack thickness

(76) Inventors: Stacey Lynn Pomeroy, De Pere, WI (US); John David Amundson, Greenville, WI (US); Joseph Robert Riegert, Black Creek, WI (US); Gerald Keith Sosalla, Appleton, WI (US); Drea Clark Bruss, Oshkosh, WI (US); John Martin Wydeven, Little Chute, WI (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/784,071

(22) Filed: Apr. 5, 2007

(51) Int. Cl. B32B 3/04

(52) U.S. Cl. 428/121

(57) ABSTRACT

A product including a plurality of sheets formed from a basesheet material comprising at least 1.0 percent natural fibers. The plurality of sheets impregnated with a liquid, and having a moisture content between about 150 weight percent to about 600 weight percent. Each of the plurality of sheets folded to form at least one folded edge and the plurality of folded sheets placed one on top of another to form a wet wipes stack. The wet wipes stack having a Calculated per Layer Stack Thickness of greater than about 0.52 mm.

### BACKGROUND

Wet wipes containing a significant quantity of natural fibers, such as wood pulp, can absorb more water on a gram per gram basis than wet wipes containing only synthetic fibers. This can provide for improved cleaning when using the wet wipe. Furthermore, wet wipes having a significant quantity of natural fibers can be less expensive to manufacture than wet wipes containing only synthetic fibers owing to the cost advantage of some natural fibers over synthetic fibers. However, natural fibers can be less resilient to compressive forces as compared to synthetic fibers. This can be especially true when the natural fibers are saturated or moistened with a significant quantity of water. Wet collapse of the natural fiber's structure can be more pronounced than wet collapse of the synthetic fiber's structure since the natural fibers will tend to absorb more liquid than the synthetic fibers. When wet wipes are manufactured to a similar basis weight and converted into stacks, the wet wipes having a significant percentage of natural fibers can be less thick than wet wipes containing only synthetic fibers. Therefore what is needed is a wet wipe containing a significant percentage of natural fibers that also has an improved stack thickness.

### SUMMARY

Hence, in one embodiment, the invention resides in a product including a plurality of sheets formed from a basesheet material comprising at least 1.0 weight percent natural fibers; the plurality of sheets impregnated with a liquid, and having a moisture content between about 150 weight percent to about 600 weight percent; each of the plurality of sheets folded to form at least one folded edge; the plurality of folded sheets placed one on top of another to form a wet wipes stack; and wherein a Calculated per Layer Stack Thickness of the wet wipes stack is greater than about 0.52 mm.

### BRIEF DESCRIPTION OF THE DRAWINGS

The above aspects and other features, aspects, and advantages of the present invention will become better understood with regard to the following description, appended claims, and accompanying drawings in which:

FIG. 1 illustrates a schematic view of an apparatus and process for forming a stack of fan folded material.

FIG. 1A illustrates a cross sectional view taken along line 1A-1A in FIG. 1.

FIG. 2 illustrates a front view portion of the apparatus in FIG. 1.

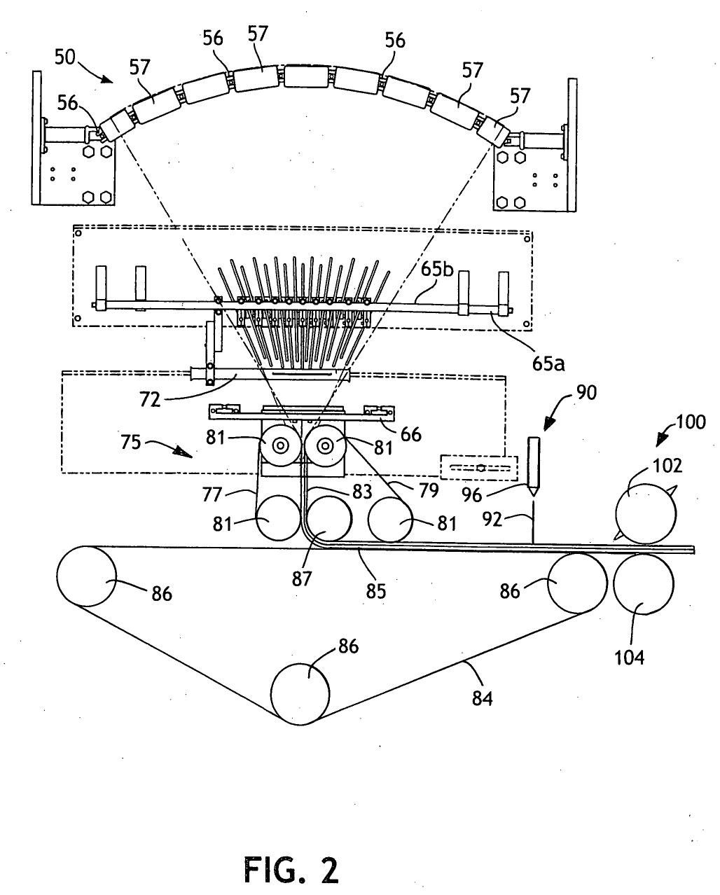

FIGS. 3, 3B, 3C, and 4 illustrate side views of a portion of clips of fan folded sheets.

FIGS. 3A and 4A illustrate top views of a portion of the sheets of FIGS. 3 and 4.

FIG. 5 is a bar graph of Calculated per Layer Stack Thickness for various wet wipes that have been folded and assembled into a stack containing a plurality of folded sheets.

Repeated use of reference characters in the specification and drawings is intended to represent the same or analogous features or elements of the invention.

### DEFINITIONS

As used herein, including the claims, forms of the words “comprise,” “have,” and “include” are legally equivalent and open-ended. Therefore, additional non-recited elements, functions, steps or limitations may be present in addition to the recited elements, functions, steps, or limitations.

As used herein “natural fiber” includes fibers obtained from vegetables, plants, trees, or animals. Examples include but are not limited to wood pulp, cotton, linen, jute, hemp, milkweed, silk, and wool.

As used herein “synthetic fiber” includes fibers derived from polypropylenes, polyethylenes, polyolefins, polyesters, polyamides, and polyacrylics. Synthetic fibers also include regenerated cellulosic fibers such as viscose rayon, cuprammonium rayon, and solvent-spun cellulose, such as Lyocell.

### DETAILED DESCRIPTION

It is to be understood by one of ordinary skill in the art that the present discussion is a description of specific embodiments only and is not intended to limit the broader aspects of the present invention.

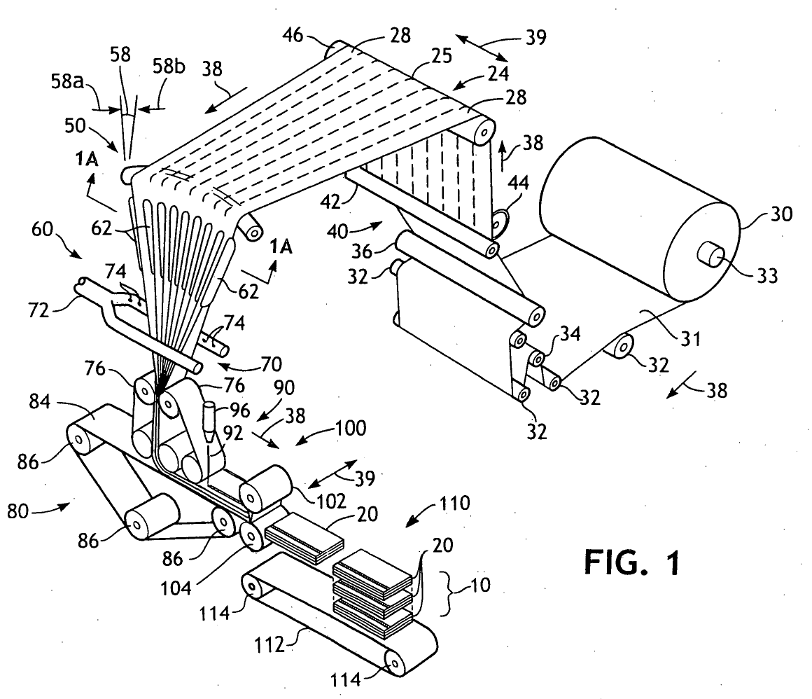

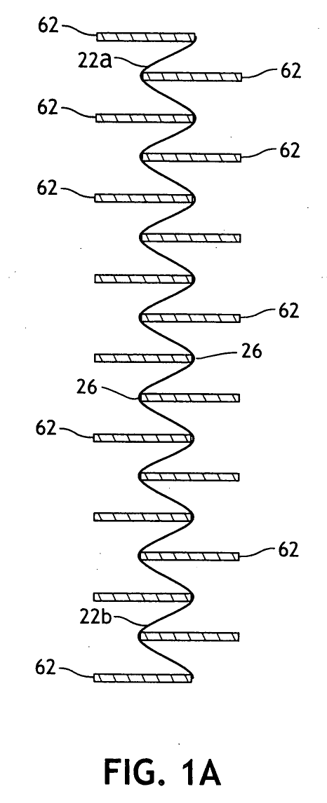

Referring to FIG. 1, there is depicted an apparatus and process for making a stack 10 of fan folded material. Starting on the right side of FIG. 1, there is a roll 30 of basesheet material 31. The roll can be supported by a roll support 33. The material is fed from the roll 30 through a series of advancing rollers such as idler rollers 32 and dancer roller 34. From there the web of material 31 travels to a slitter assembly 40. The slitter assembly can include an anvil roller 42 and slitting blades 44 that form weakened lines 24 (e.g., perforated slitting blades that thereby form perforations 25) in the sheet as it travels in the machine direction 38 through the slitting assembly. As a result of traveling through the slitting assembly, the web is formed into a plurality of panels 28 joined to adjacent panels along the plurality of weakened lines 24. From there the sheet travels over an upper idler roller 46 and over to an arched roller assembly 50. The web then travels into the folding assembly 60. The folding assembly includes a series of folding boards 62 that assist in necking down the web in the cross machine direction 39 in a controlled fashion to induce a plurality of machine direction 38 folded edges 26.

As the web travels down the folding assembly 60, it encounters a moistening assembly 70. Assembly 70 can include a bar 72 having ports 74 for imparting liquid or solution onto the moving web as it is necked down into a fan folded ribbon of material. A liquid or solution can be provided at a desired add-on rate and in a conventional manner to the bar 72 so it can be applied through ports 74 to the moving web. Such application could include spraying or drooling with a bar like 72, or could include alternate structures (not shown) for techniques such as printing, a bath, or a flooded nip. As the web travels further down the folding assembly, the sheet becomes corrugated to a point where the web forms a single ribbon of fan folded sheets. The ribbon of fan folded sheets is advanced by a pull section 75.

In order to minimize wet collapse of the basesheet material 31 containing a significant percentage of natural fibers, compression of the moistened ribbon of fan folded sheets by the pull section 75 preferably is minimized. One way to minimize the compression is to use a pull section 75 having belts that contact the outer layers of the ribbon of fan folded sheets. Utilizing belts, instead of a pair of nipped rollers, may further reduce the pressure exerted on the basesheet material 31, and may also generate more traction for an equivalent loading force. In general, as the pull belt nip length is increased and overly constrictive nips are removed, the amount of wet collapse of the basesheet will decrease.

Other methods of reducing the pressure exerted on the basesheet material while drawing the moistened fan folded sheets through the apparatus 10 can be used. For example, the belts can be provided with spaced-apart protrusions that cause the fan folded sheets to assume a sinusoidal profile as disclosed in U.S. Pat. No. 5,690,263 issued to Abba et al. on Nov. 25, 1997 entitled Method for Applying a Tractive Force to a Stack of Tissues With Reduced Bulk Loss.

The pull belt section 75 includes a first belt 77 and a second belt 79 traveling in closed paths about a plurality of rollers 81. The first and second belts (77, 79) create a first extended nip 83 in the machine direction 38 through which the ribbon of fan folded sheets is advanced. Since the length of this nip can be significantly longer than the nip created by two rolls in close proximity, the tractive force generated for a given nip load is significantly increased. To further increase the tractive force generated, the second belt 79 can travel in a triangular closed path thereby forming a second extended nip 85 between the second belt and a support belt 84. The second extended nip 85 can extend in the cross machine direction 39 such that the ribbon of fan folded sheets travels in a substantially vertical path through the first extended nip 83, wraps roller 87 approximately 90 degrees, and then travels in the cross machine direction through the second extended nip 85.

By utilizing two extended nips (83, 85), compression of the ribbon of fan folded sheets can be further minimized and more tractive force generated. Additionally, by wrapping the ribbon of fan folded sheets about roller 87, thereby forming an approximately 90 degree angle of the ribbon between the first extended nip 83 and the second extended nip 85, additional tractive force is generated and slippage is further reduced than if the first and second extended nips were arranged in a straight line relationship. Wrapping roller 87 with the ribbon of fan folded sheets between the two extended nips helps to significantly reduce slippage in the pull belt section 75 when utilizing wider gaps between the belts or low loading forces of the belts. The increase in tractive force is related to the amount of the wrap angle and the diameter of idler roller 87.

The first and second belts (77, 79) can be provided with a textured surface or a smooth surface. If a textured surface is provided then protruding nipples, treads, bumps, or lugs can be used to further enhance the tractive force or the coefficient of friction of the belt when contacting the moistened basesheet material 31. One suitable belt material with a textured surface for use as the first and second belts (77, 79) is sold by Midwest Industrial Rubber Inc. having an office in St. Louis, Mo., USA, and designated as 2LR5-OWNT PVC White Nipple Top.

At this point, the single ribbon of fan folded sheets then travels by a conveyor assembly 80 including the support belt 84 and support rollers 86 which are an idler roller and a drive roller. The web continues its travel to an adhesive application assembly 90. The adhesive assembly applies adhesive 92 via an adhesive nozzle 96 to the top of the ribbon, e.g., along an edge. Adhesive can be applied by various techniques known to those of skill in the art.

The ribbon with adhesive applied thereto travels on to a cutter assembly 100, which includes a rotary cutter 102 and anvil roller 104. The ribbon is then cut into discreet pieces, called clips 20, which then pass to a stacker assembly 110. The stacker assembly includes a stacker belt 112 and stacker rollers 114 which are an idler roller and a drive roller. In the stacker assembly 110, the clips 20 are stacked one upon the other and thereby the adhesive 92 on the top sheet of a clip adheres to a bottom sheet of the subsequent clip that is stacked on top of it. A desired number of clips are stacked one on top of another and adhesively joined in this manner. An example of such an apparatus for use as the stacker assembly is provided with a variety of conventional wet wipe machines sold by Paper Converting Machine Company of Green Bay, Wis., USA, under the tradename Triton™ Wet Wipes Machine. Other stackers that could be employed are those supplied with a ZFV™ folder, sold by Elsner Engineering of Hanover, Pa., USA, or a Serv-O-Tec™ folder sold by Serv-O-Tec in Lagenfeld, Germany (Serv-O-Tec is a division of Bretting Mfg. in Ashland, Wis., USA). Then, the completed stack is moved to a packaging assembly (not shown) where the clips can be put in various types of dispensers (e.g., tubs, bags, etc.) and then made ready for commercial sale and use.

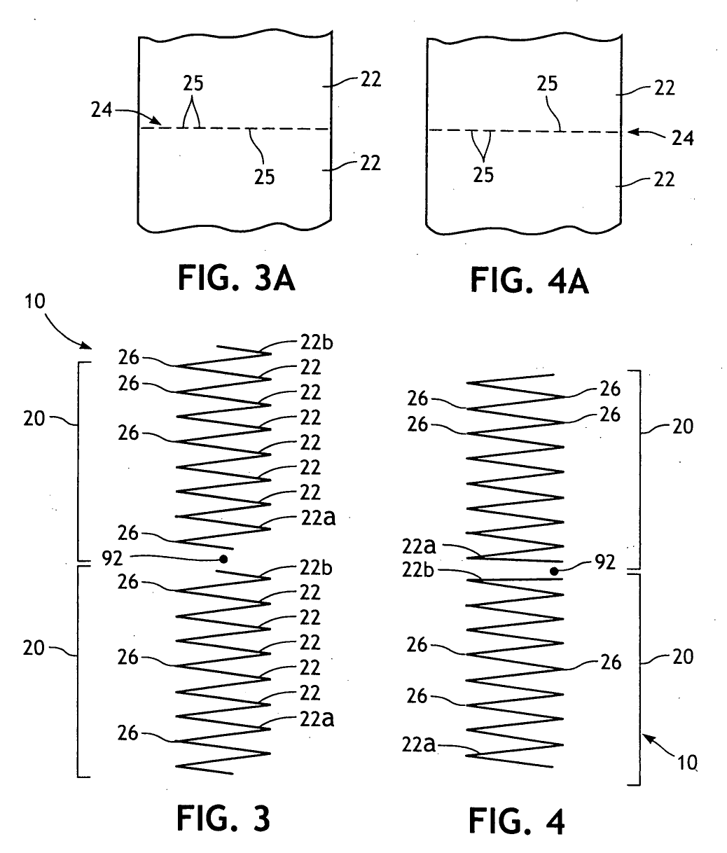

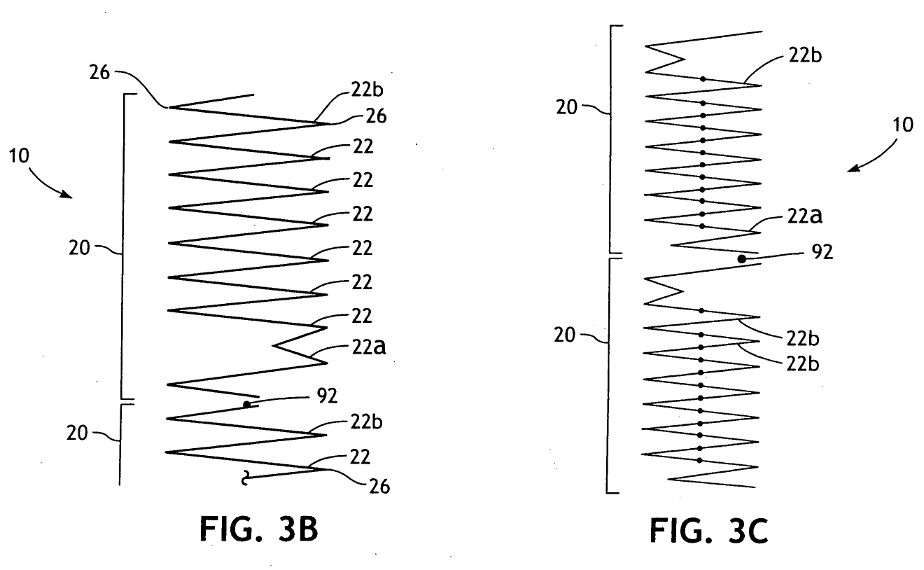

Generally, and referring to FIGS. 3 to 4A, inclusive, the stack 10 can include at least two clips 20 where each clip comprises at least two sheets 22 separably joined together along a weakened line 24. Each clip 20 is separably joined to an adjacent clip, e.g., advantageously by the last sheet 22a of one clip being joined to the first sheet 22b of a succeeding clip. Stacks of fan folded material can have any sheet in one clip joined to any sheet in a succeeding clip as long as dispensing of sheets from a preceding clip dispenses simultaneously at least one sheet of a succeeding clip so as to continue successive dispensing of the entire stack 10, as desired. The sheets 22 in FIG. 4 are also a plurality of individual sheets like those in FIG. 3, although each sheet is not separately numbered as in FIG. 3. The sheets 22 in FIG. 3B are also a plurality of individual sheets like those in FIG. 3. As seen in FIGS. 3A and 4A, a top view of a portion of the sheets in the clips shows the individual sheets of the clips can be separably joined together along weakened lines 24, such as lines of perforations 25, to ensure that the trailing sheet is in position for grasping by a user after the leading sheet is removed. Generally, the portion of the web of material between successive weakened lines defines each individual sheet. Folded edges 26, which are formed in the machine direction, generally define the width of the clip. In use, the clip can be dispensed in the so-called pop-up format so that once the first sheet of the stack of fan folded sheets is dispensed through a dispenser's orifice, each succeeding sheet will be at least partially pulled through the dispensing orifice before the leading sheet is fully separated from the succeeding sheet, as desired. That is, each sheet within the stack is separably joined to an adjacent sheet by either a weakened line relationship or an adhesive relationship, thus enabling, as desired, one-after-another dispensing for the entire stack once the initial sheet is dispensed. Alternatively, the stack could be used for so-called reach-in dispensing, and the user would have to actively assist in separating the lead sheet from the succeeding sheet each time dispensing is desired. Further information concerning the stack 10 formed or the apparatus to form the stack 10 are disclosed in U.S. Pat. No. 6,612,462 issued to Sosalla et al. on Sep. 2, 2003 entitled Stack of Fan Folded Material and Combination Thereof; U.S. Pat. No. 6,749,083 issued to Sosalla et al. on Jun. 15, 2004 entitled Stack of Fan Folded Material and Combination Thereof, and in U.S. Pat. No. 6,905,748 issued to Sosalla et al. on Jun. 14, 2005 entitled Stack of Fan Folded Material and Combination Thereof all of which are herein incorporated by reference.

The plurality of sheets 22, such as a stack 10 of sheets, can include any suitable number of individual sheets depending upon the desired packaging and end use. For example, the stack 10 can be configured to include at least about 5 wet wipes and desirably from about 16 to about 320 individual sheets, and more desirably from about 32 to about 160 sheets. The size and shape of the stack of sheets 22 is dependent upon the size and shape of the package/dispenser and vice versa. For example, the length of an assembled stack of wet wipes sheets can be about 190 mm, with a height of about 90 mm and a width of about 100 mm.

Each sheet is generally rectangular in shape and defines a pair of opposite side edges and a pair of opposite end edges which can be referred to as a leading end edge and a trailing end edge. Each sheet defines an unfolded width and an unfolded length. The sheets can have any suitable unfolded width and length. For example, sheets of wet wipes can have an unfolded length of from about 2.0 to about 80.0 centimeters or from about 10.0 to about 26.0 centimeters and an unfolded width of from about 2.0 to about 80.0 centimeters or from about 10.0 to about 45.0 centimeters.

Basesheet materials suitable for the wet wipes formed into stacks are well known to those skilled in the art. The wet wipe sheets can be made from any material suitable for use as a wipe, including meltblown, coform, airlaid, bonded-carded web materials, spunlace, hydroentangled materials, high wet-strength tissue and the like and can comprise natural fibers, synthetic fibers, or combinations thereof. The basesheet material used to make the wet wipes, can have a dry basis weight of from about 25 to about 120 grams per square meter (gsm) or from about 40 to about 90 gsm. Furthermore, the basesheet material 31 includes at least a positive, non-zero weight percent of natural fibers, such as at least 1.0 weight percent natural fibers. Desirably, the basesheet material 31 includes a significant percentage of natural fibers such as between about 5 weight percent to about 90 weight percent of natural fibers, or between about 20 weight percent to about 80 weight percent of natural fibers, or between about 60 weight percent to about 75 weight percent of natural fibers. Increasing the natural fiber content may be desirable to decrease overall cost, increase tactile softness, or improve environmental sustainability. For example, a basesheet material having a high percentage of natural fibers can be perceived as softer than a basesheet material having no natural fibers; however, such a basesheet material when made into a stack of wet wipes is more likely to have a reduced stack thickness believed to result from wet collapse of the natural fibers. Thus, the percentage of natural fibers included may be limited as a result of manufacturing capabilities or for product durability requirements. The percent of natural fibers in a sheet can vary depending on the attributes desired for that particular product and the process capabilities by which it's made.

In a particular aspect, the basesheet material 31 used to make the wet wipes can comprise a coform basesheet material of polymeric microfibers admixed with cellulosic fibers. The coform material can have a basis weight of from about 60 to about 100 gsm or about 80 to 85 gsm. Such coform basesheet materials can be manufactured as described in U.S. Pat. No. 4,100,324 issued to Anderson et al. on Jul. 11, 1978 entitled Nonwoven Fabric and Method of Producing Same; U.S. Pat. No. 6,946,413 issued to Lange et al. on Sep. 20, 2005 entitled, Composite Material With Cloth-like Feel; U.S. Pat. No. 5,508,102 issued to Georger et al. on Apr. 16, 1996 entitled Abrasion Resistant Fibrous Nonwoven Composite Structure; and in U.S. Patent Application Publication US 2003/0211802 by Keck et al. on Nov. 13, 2003 entitled Three-Dimensional Coform Nonwoven Web all of which are herein incorporated by reference.

Typically, such coform basesheets comprise a gas-formed matrix of thermoplastic polymeric meltblown microfibers, such as, for example, polypropylene microfibers, and cellulosic fibers, such as, for example, wood pulp fibers. The relative percentages of the polymeric microfibers and cellulosic fibers in the coform basesheet can vary over a wide range depending on the desired characteristics of the wet wipes. For example, the coform basesheet can comprise from about 10 to about 95 weight percent, from about 20 to about 80 weight percent, or from about 25 to about 40 weight percent of polymeric microfibers based on the dry weight of the coform basesheet being used to provide the wet wipes. An example of a coform basesheet is found in the baby wipes product presently sold by Kimberly-Clark Corporation and known as HUGGIES® Natural Care.

The wipes 22 contain a liquid which can be any solution that can be absorbed into the wipes, thus making them “wet wipes.” They can be moistened some time during the manufacturing process before or contemporaneous with the plurality of wipes being sealed in a dispenser or other packaging for next use by a product user. Desirably, the wet wipes are moistened with a liquid prior to being formed into a stack as show in FIG. 1. This method can provide a stack of wet wipes having a more uniform distribution of moisture within the wet wipes stack. The liquid contained within or by the wet wipes can include any suitable components which provide the desired wiping properties. For example, the components can include water, emollients, surfactants, preservatives, chelating agents, pH buffers, fragrances or combinations thereof. The liquid can also contain lotions, ointments and/or medicaments. An example of a suitable liquid for applying to the basesheet material 31 to form a wet wipe is disclosed in U.S. Pat. No. 6,673,358 issued to Cole et al. on Jan. 6, 2004 entitled Wet Wipes Containing a Mono Alkyl Phosphate and herein incorporated by reference.

The amount of liquid or solution contained within each wet wipe can vary depending upon the type of basesheet material being used to make the wet wipe, the type of liquid being used, the type of container being used to store the stack of wet wipes, and the desired end use of the wet wipe. Generally, each wet wipe can contain from about 25 weight percent to about 600 weight percent or from about 150 weight percent to about 600 weight percent liquid based on the dry weight of the wipe. To determine the liquid add-on, first the weight of a just-manufactured dry wipe is determined. Then, the amount of liquid by weight equal to the weight of the just-manufactured dry wipe, or an increased amount of liquid measured as a percent add-on based on the weight of the just-manufactured dry wipe, is added to the wipe to make it moistened, and then known as a “wet wipe” or “wet wipes.”

In a particular aspect, the amount of liquid contained within the wet wipe can be from about 250 weight percent to about 400 weight percent or about 330 weight percent based on the dry weight of the wet wipe. If the amount of liquid is less than the above-identified range, the wet wipes can be too dry and may not adequately perform depending on the intended use. If the amount of liquid is greater than the above-identified range, the wet wipes can be over saturated and soggy, which may result in increased wet collapse of the natural fibers during the converting process. Furthermore, the liquid can pool in the bottom of the container as well as contribute to problems with the adhesive 92 sticking to the surface of wet wipe sheets 22 if the wipes are over saturated.

The plurality of sheets, e.g., wet wipes, are arranged in a stack 10 and placed into a package or dispenser that provides convenient and reliable one at a time dispensing, and which assists the wet wipes in not becoming overly dry. Suitable dispensers can include flexible film packages with a peel and reseal label, flexible bags typically supplied for use to refill another dispenser, and rigid plastic containers that function as a dispenser.

The wet wipe sheets 22 contained in the stack 10 can be folded into a perforated Z-fold (Perf-Z) where an individual sheet 22 between ensuing perforations has a full width center panel and an upper and lower partial width panel as seen in FIGS. 3-4. Thus, each individual wet wipe 22 within the stack 10 contributes approximately two layers of thickness to the final overall stack height. Other suitable folding techniques can be used to assemble the stack 10 such as a modified V-fold (Mod-V) as disclosed in U.S. Pat. No. 5,497,903 issued to Yoneyama on Mar. 12, 1996 entitled Multiple Folded Paper for Continuous Disposal; a V-Z fold (V-Z) as disclosed in U.S. Pat. No. 6,045,002 issued to Wierschke on Apr. 4, 2000 entitled Stack Comprising V-Z folded Sheets; or a double Z-fold (Dbl-Z) as disclosed in U.S. Pat. No. 6,202,845 issued to Hill on Mar. 20, 2001 entitled Folding And Stacking Configuration For Wet Wipes all herein incorporated by reference. In all of the above folding techniques, the folded stack width measured between the folded edges 26 of the stack is approximately one-half the unfolded sheet width. On average within each resulting stack produced by the above folding methods, each individual wet wipe 22 within the stack 10 contributes two layers of thickness to the final overall stack height.

Consumers of wet wipes generally prefer wet wipes having an increased thickness. One way to compare the thickness of wet wipes is to calculate the per layer stack thickness by measuring the overall stack height for the stack 10, dividing the stack height by the stack count or number of individual sheets 22 in the stack 10, and dividing the result by a factor 2 since each folded sheet contributes approximately two layers. However, such a calculation fails to account for differing basis weights of the basesheet material 31. Generally, for a given type of material, an increase in basis weight produces an increase in the sheet's thickness. Typical basesheet materials 31 used to make wet wipes often have a dry basis weight between about 45 gsm to about 75 gsm with material close to 60 gsm being fairly common. Thus, one way to compare the calculated stack thickness per layer for different stacks is to normalize for differences in the basis weight of the basesheet material used to make the wet wipes. Since a common basis weight for wet wipes is approximately 60 gsm, the actual basis weight of the basesheet material in the stack can be normalized to 60 gsm.

Therefore, the Calculated per Layer Stack Thickness can be determined by the following equation:

$$Calculated per Layer Stack Thickness ( mm ) = \frac{\frac{Stack Height ( mm )}{Sheet Count} \times \frac{60 ( gsm )}{Basis Weight ( gsm )}}{2 ( layers per sheet )}$$

In one embodiment, stacks of wet wipes were manufactured using the above disclosed converting process having a pull belt section 75 that significantly reduced the compressive forces on the moist basesheet material resulting in wet wipes having an increased sheet thickness at the same basis weight. The resulting Calculated per Layer Stack Thickness was compared to commercially available wet wipes in the United States of many different types. Table 1 below lists data for Examples of the present invention, having reduced converting Z-direction compression, and for Comparative samples of commercially available wet wipes.

TABLE 1

| | Calculated per | | |
|---|---|---|---|
| | Layer Stack | | |
| Sample | Thickness (mm) | Description | Basesheet |
| Comparative 1 | 0.343 | Walgreens Comfort Smooth | Spunlace |
| Comparative 2 | 0.362 | PAMPERS Sensitive | Spunlace |
| Comparative 3 | 0.375 | Equate Pop-Ups | Airlaid |
| Comparative 4 | 0.381 | Target Baby Wipes | Airlaid |
| Comparative 5 | 0.406 | Kroger Comforts | Spunlace |
| Comparative 6 | 0.409 | Kirkland Signature | Spunlace |
| Comparative 7 | 0.429 | Parents Choice | Airlaid |
| Comparative 8 | 0.440 | PAMPERS Natural Aloe | Spunlace |
| Comparative 9 | 0.455 | JOhnson's Baby Softcare | Spunlace |
| Comparative 10 | 0.470 | Parents Choice Organic | Spunlace |
| Comparative 11 | 0.476 | HUGGIES ® Natural Care | Coform |
| | | 5-2006 | |
| Comparative 12 | 0.481 | Nivea Baby | Spunlace |
| Comparative 13 | 0.500 | HUGGIES ® Supreme | Coform |
| | | 5-2006 | |
| Comparative 14 | 0.528 | CVS SoftCloth Supreme | Spunlace |
| Example 1 | 0.531 | HUGGIES ® Natural Care | Coform |
| | | pull belt converted | |
| Example 2 | 0.563 | HUGGIES ® Supreme pull | Coform |
| | | belt converted | |
| Example 3 | 0.580 | Hand Folded Prototype | Coform |
| Comparative 15 | 0.645 | Parent's Choice | Spunlace |
| Example 4 | 0.708 | Hand Folded Prototype | Coform |

| | | | | Measured | | Stack |
|---|---|---|---|---|---|---|
| | Solution | Natural | Fold | Stack | | Count |
| Sample | Add-on (%) | Fibers (%) | Type | Height (mm) | Basis Weight (gsm) | (sheets) |
| Comparative 1 | 240 | 0 | Mod-V | 53 | 58 | 80 |
| Comparative 2 | 320 | 0 | Dbl-Z | 54 | 64 | 70 |
| Comparative 3 | 340 | 71 | Mod-V | 63 | 63 | 80 |
| Comparative 4 | 270 | 72 | V-Z | 61 | 60 | 80 |
| Comparative 5 | 290 | 0 | Mod-V | 66 | 61 | 80 |
| Comparative 6 | 290 | 22 | V-Z | 72 | 60 | 88 |
| Comparative 7 | 280 | 74 | V-Z | 71 | 62 | 80 |
| Comparative 8 | 320 | 0 | Dbl-Z | 70 | 62 | 77 |
| Comparative 9 | 300 | 0 | V-Z | 80 | 60 | 88 |
| Comparative 10 | 320 | 24 | V-Z | 62 | 55 | 72 |
| Comparative 11 | 330 | 73 | Perf-Z | 80 | 63 | 80 |
| Comparative 12 | 300 | 0 | V-Z | 64 | 57 | 70 |
| Comparative 13 | 330 | 70 | Z-Fold | 90 | 75 | 72 |
| Comparative 14 | 260 | 0 | V-Z | 83 | 59 | 80 |
| Example 1 | 330 | 73 | Perf-Z | 85 | 60 | 80 |
| Example 2 | 330 | 66 | Perf-Z | 90 | 75 | 64 |
| Example 3 | 330 | 66 | Z-Fold | 85 | 55 | 80 |
| Comparative 15 | 300 | 0 | V-Z | 82 | 53 | 72 |
| Example 4 | 330 | 66 | Z-Fold | 85 | 45 | 80 |

Examples 1 and 2 were manufactured using the apparatus illustrated in FIG. 1. They can be compared to Comparative 11 and Comparative 13, which were made on an apparatus that had nip rollers as shown in U.S. Pat. No. 6,905,748 instead of a pull belt section 75 illustrated in FIG. 1. As seen in Table 1, the wet wipes manufactured using the pull belt section had a significantly greater Calculated per Layer Stack Thickness than the wet wipes manufactured using nip rollers. For example, the Calculated per Layer Stack Thickness increased to 0.531 mm from 0.476 mm for the HUGGIES® Natural Care wet wipes.

Examples 3 and 4 were made by hand using a hand sprayer to moisten the basesheet material 31, hand folded into a non-interleaved Z-fold, and then hand stacked to make the wet wipes stack 10. Examples 3 and 4 represent a theoretical minimum in the compressive forces present when assembling a wet wipes stack. Even though the basesheet material 31 contained a significant percentage of natural fibers that offers less compressive resistance when wet than synthetic fibers, in Examples 3 and 4 the Calculated per Layer Stack Thickness was significantly better than all the other wet wipes stacks formed from a basesheet material containing natural fibers. Other than Comparative 15, which contained no natural fibers, Examples 3 and 4 were better than the other Comparative samples made from 100 percent synthetic fibers.

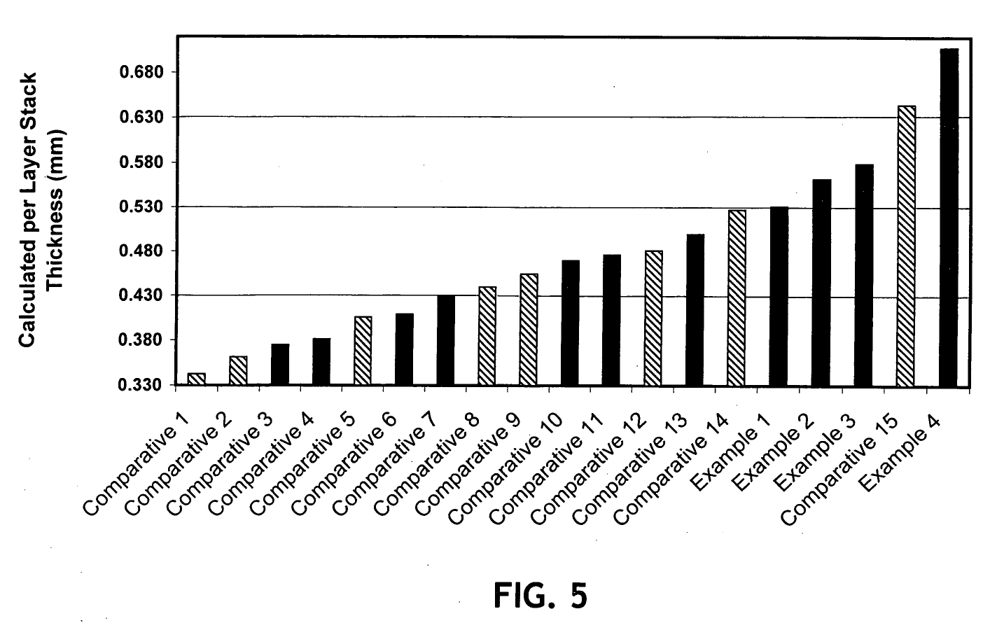

The Calculated per Layer Stack Thickness for the data in Table 1 is illustrated in FIG. 5. Data points illustrated in solid black represent wet wipe stacks formed from a basesheet material 31 containing a significant percentage of natural fibers. Data points illustrated in striped lines represent wet wipe stacks formed from a basesheet material 31 containing only synthetic fibers. As seen, the Examples had significantly higher Calculated per Layer Stack Thickness than almost all the other samples and had significantly higher Calculated per Layer Stack Thickness than all the other samples containing a significant percentage of natural fibers.

In various embodiments, the Calculated per Layer Stack Thickness for wet wipes of the present invention containing a significant amount of natural fibers can be greater than about 0.52 mm, or between about 0.52 mm to about 1.0 mm, or between about 0.52 mm to about 0.75 mm, or between about 0.53 mm to about 1,0 mm, or between about 0.53 mm to about 0.75 mm.

### Test Methods

### Stack Height Measurement

Gently remove the wet wipes stack from the container it is packaged in and place onto a smooth level surface without bunching, shifting, or otherwise disturbing the wet wipes within the stack. The stack height 10 is measured using a thin (⅛ inch or less), flat aluminum platen having a size slightly larger than the surface area of the stack's top that is placed onto the stack's top, or by placing the straight edge of a metal ruler lightly onto the stack's top surface. The stack height should be measured to the nearest mm by measuring the distance between the top of the reference surface the stack is placed on and the bottom edge of the platen or ruler touching the stack's top. If the top surface of the stack is slightly uneven, the largest height measured is recorded ignoring loose, wrinkled, or obviously displaced sheets at the top surface. If wrinkled or displaced sheets are present, the stack should be discarded and a new stack measured. At least three stack height measurements are obtained for each sample being tested. The average of the three individual measurements is recorded as the stack height. After measuring the stack height, the number of sheets within the stack should be determined by dispensing the stack and counting each individual sheet.

### Basis Weight

The dry basis weight of the basesheet material 31 forming the wet wipes in the stack can be obtained using the ASTM active standard D646-96(2001), Standard Test Method for Grammage of Paper and Paperboard (Mass per Unit Area), or an equivalent method.

Modifications and variations to the present invention may be practiced by those of ordinary skill in the art, without departing for the spirit and scope of the present invention, which are more particularly set forth in the appended claims. It is understood that aspects of the various embodiments may be interchanged in whole or part. All cited references, patents, or patent applications in the above application for letters patent are herein incorporated by reference in a consistent manner. In the event of inconsistencies or contradictions between the incorporated references and this specification, the information present in this specification shall prevail. The preceding description, given by way of example in order to enable one of ordinary skill in the art to practice the claimed invention, is not to be construed as limiting the scope of the invention, which is defined by the claims and all equivalents thereto.

We claim:

1. A product comprising:
a plurality of sheets formed from a basesheet material comprising at least 1.0 weight percent natural fibers;
the plurality of sheets impregnated with a liquid, and having a moisture content between about 150 weight percent to about 600 weight percent;
each of the plurality of sheets folded to form at least one folded edge;
the plurality of folded sheets placed one on top of another to form a wet wipes stack; and
wherein a Calculated per Layer Stack Thickness of the wet wipes stack is greater than about 0.52 mm.

2. The product of claim 1 wherein the Calculated per Layer Stack Thickness is between about 0.52 mm to about 1.0 mm.

3. The product of claim 1 wherein the Calculated per Layer Stack Thickness is between about 0.53 mm to about 0.75 mm.

4. The product of claim 1 wherein the basesheet material comprises between about 5 weight percent to about 90 weight percent of natural fibers.

5. The product of claim 2 wherein the basesheet material comprises between about 20 weight percent to about 80 weight percent of natural fibers.

6. The product of claim 3 wherein the basesheet material comprises between about 60 weight percent to about 75 weight percent of natural fibers.

7. The product of claim 1 wherein the basesheet material comprises coform.

8. The product of claim 2 wherein the basesheet material comprises coform.

9. The product of claim 3 wherein the basesheet material comprises coform.

10. The product of claim 4 wherein the basesheet material comprises coform.

11. The product of claim 5 wherein the basesheet material comprises coform.

12. The product of claim 6 wherein the basesheet material comprises coform.

13. The product of claim 1 wherein the moisture content is between about 250 weight percent to about 400 weight percent.

14. A product comprising:
a plurality of sheets formed from a basesheet material comprising coform and containing between about 20 weight percent to about 80 weight percent natural fibers;
the plurality of sheets impregnated with a liquid, and having a moisture content between about 250 weight percent to about 400 weight percent;
each of the plurality of sheets folded to form at least one folded edge;
the plurality of folded sheets placed one on top of another to form a wet wipes stack; and
wherein a Calculated per Layer Stack Thickness of the wet wipes stack is greater than about 0.52 mm.

15. The product of claim 14 wherein the Calculated per Layer Stack Thickness is between about 0.52 mm to about 1.0 mm.

16. The product of claim 14 wherein the Calculated per Layer Stack Thickness is between about 0.53 mm to about 0.75 mm.

17. The product of claim 15 wherein the basesheet material comprises between about 60 weight percent to about 75 weight percent of natural fibers.

18. The product of claim 16 wherein the basesheet material comprises between about 60 weight percent to about 75 weight percent of natural fibers.

19. The product of claim 14 wherein the moisture content is about 330 weight percent.

20. The product of claim 18 wherein the moisture content is about 330 weight percent.
